(19) United States
(12) Patent Application Publication
(10) Pub. No.: US 2008/0041599 A1
(43) Pub. Date: Feb. 21, 2008

(54) SMART FLOW SYSTEM FOR FIRE FIGHTING

(76) Inventors: Joel Mulkey, Aloha, OR (US); Scott Malone, Gaston, OR (US)

Correspondence Address: GANZ LAW, P.C., P O BOX 2200, HILLSBORO, OR, 97123, US

(21) Appl. No.: 11/780,437

(22) Filed: Jul. 19, 2007

Related U.S. Application Data
(60) Provisional application No. 60/831,799, filed on Jul. 19, 2006.

(51) Int. Cl. A62C 37/08

(52) U.S. Cl. 169/60

(57) ABSTRACT

In fire-fighting, a method of controlling operation of a fire apparatus as to at least one hose lay, the method comprising acquiring data at a location associated with the hose lay; communicating at least some of the acquired data from the remote location so as to be receivable at or adjacent to the fire apparatus; and based at least in part on at least some of the so-communicated data, controlling operation of the fire apparatus.

### RELATED APPLICATIONS

This application claims the benefit of and priority to U.S. provisional patent application No. 60/831,799, filed Jul. 19, 2006, by Joel Mulkey and Scott Malone entitled Smart Flow Nozzle Wireless Piezometer, the contents of which are hereby incorporated by reference as if recited in full herein for all purposes.

### BACKGROUND

The inventive subject matter relates to devices, systems and methods with application to control fluid flow from a fire fighting apparatus (e.g., a fire truck).

The inventive subject matter of this application arises based on recognizes certain inefficiencies and sometimes dangerous situations caused by improper water pressure being pumped to nozzles at the end of hose lays.

As shown in FIG. 1, the fire fighting service determines what pump pressure (pound per square inch, or PSI) is necessary in order to deliver a certain nozzle PSI through use of a complex of friction loss formulas and tables, which tables generally are based on obsolete, inapplicable or otherwise inadequate friction loss test results. As indicated by Table 1, PSI generally should be calculated with consideration of: the length and diameter of hoses in the hose lay; nozzle type, splitters (e.g., so-called “wyes”) and any other appliances of the hose lay; elevation, including ground elevation variations and building elevations; flow volume of water and flow/no-flow context (i.e., whether the nozzle is open or closed); and other scene/event-specific issues (e.g., kinks in the hose). Generally, the friction loss formulas and tables reflect some of these factors (e.g., elevation and nozzle/appliance arrangement) only generally (i.e. not specific to the actual hose lay and scene/event specific parameters) and/or omit certain factors entirely (e.g., hose age and associated performance shortfalls or variations; hose type (e.g., double jacketed, materials of construction, such as synthetic).

Although numerous factors need to be considered in using such tables and doing so repeatedly over the duration of the event, the engineer generally has less than optimal time to do so, i.e., the engineer typically is busy obtaining a water supply, throwing a fan and ladder, and communicating with other engineers. The ultimate PSI pumped is usually a generalized estimate or best guess, e.g., based on the engineer's intuition/experience and/or whether the fire fighters at the nozzle are complaining about too high or too low a pressure.

The subject matter of this application: pumping water in fire fighting operations and, more particularly, for controlling pumping parameters of a fire-fighting pump using telemetry. As an example, the subject matter of this application provides for: (i) acquiring data at a location remote from a fire truck that pumps water (“pumper truck”); (ii) communicating at least some of the acquired data from the remote location to the pumper and (iii) based at least in part on at least some of the so-communicated data, controlling pumping action of the pumper truck.

### SUMMARY

The inventive subject matter generally provides for feedback to the fire apparatus as to one or more selected operating parameters. As an example, the selected operating parameter(s) may be applicable at or adjacent to (i) a nozzle, (ii) one or more other appliances, and/or (iii) selected other part(s) of a hose lay. As an example, an operating parameter may be the pressure of water flowing out of the nozzle, i.e., toward extinguishing a fire. As an example, the feedback may be provided wirelessly (e.g., via 802.11, 900 mHz telephonic technology, etc.). As an example, the feedback may be provided to either/both (a) a display (e.g., LCD, LED etc) associated with the engineer who operates the fire apparatus (e.g., a display mounted on or at the Engineers Panel of a fire apparatus which display provides information to the engineer in form relevant to the one or more operating parameters (e.g., display of a real-time or selected pressure or flow volume through a nozzle or at/out the nozzle's orifice) and (b) directly to the fire apparatus for automatic control responsive to such feedback. In an example embodiment, the feedback is provided to the fire apparatus' electronic governor so as to control automatically (i.e., with no additional user input). In an example embodiment, the electronic governor is designed and implemented so as to receive and respond to such feedback. In another example embodiment, the existing electronic governor is not designed or implemented to receive that feedback and, in order to receive and act on the feedback, a component is provided that enables such receipt and use (e.g., the component comprising an apparatus interface that provides either/both mechanical, electrical, electronic or other interfacing compliant with the particular requirements of the existing electronic governor). In an example embodiment having direct feedback, the devices, systems and methods may be implemented so that an engineer may be enabled to override, manually adjust or otherwise intercede in the operation of the fire apparatus, e.g., by turning off the feedback, adjusting the feedback, adjusting the response to the feedback or otherwise bypassing the feedback or implementing human input (e.g., intuition or expertise).

The inventive subject matter responds to the current system of calculating/estimating friction loss in fire fighting, i.e., using memory, intuition and/or experience, alone or together with friction loss tables. The current system has various problems and shortfalls, including that the friction loss tables may be outdated, that the tables do not account for all factors that effect the selected operating parameter(s) (e.g., environmental factors), and that the tables do not provide direction as to all hose lays (e.g., the various combinations of hose (e.g. type and length), appliances, and nozzles). The current system also generally relies on having an engineer operating the fire apparatus (i.e., rather than otherwise fighting the fire).

The inventive subject matter, in an example embodiment, provides immediate or substantially immediate feedback to the fire apparatus, which feedback reflects one or more actual operating parameter(s) at the one or more point(s) from which the feedback data is obtained. As such, the feedback data generally accounts for most, if not all factors, that effect the selected operating parameter(s).

The inventive subject matter is expected to result in safer, more effective, more efficient and cost effective fire suppression.

These and other embodiments are described in more detail in the following detailed descriptions and the figures.

The foregoing is not intended to be an exhaustive list of embodiments and features of the inventive subject matter. Persons skilled in the art are capable of appreciating other embodiments and features from the following detailed description in conjunction with the drawings.

### BRIEF DESCRIPTION OF THE FIGURES

The following figures illustrate certain possible embodiments and features according to the inventive subject matter.

FIG. 1 shows a prior art diagram of the firefighting system with a firetruck, hose connections to a fire hydrant, single line and wye connected firehoses, and a fire engineer;

FIG. 2 depicts a cut away view of the device depicting the circuit board, the pressure sensor, and the power supply;

FIG. 3 is an axial view of the device depicting the circuit board, the pressure sensor, and the power supply;

FIG. 4 is a general system diagram of the system for wireless monitoring the water flow in the firehose;

FIG. 5 is a schematic diagram of the transmitter section of the wireless system for monitoring the waterflow in the firehose;

FIG. 6 is a schematic diagram of the receiver section of the wireless system for monitoring the waterflow in the firehose;

FIG. 7 is a flowchart of the system operation for monitoring the waterflow in a firehose;

FIG. 8 is a flowchart of the receiver subsystem for monitoring the waterflow in a firehose;

FIG. 9 is a detailed flowchart of the transmitter/sensor subsystem that monitors the waterflow in a firehose.

FIG. 10 is a flowchart of the subsystem depicting a closed loop system for controlling the waterflow in the firehose.

### DETAILED DESCRIPTION

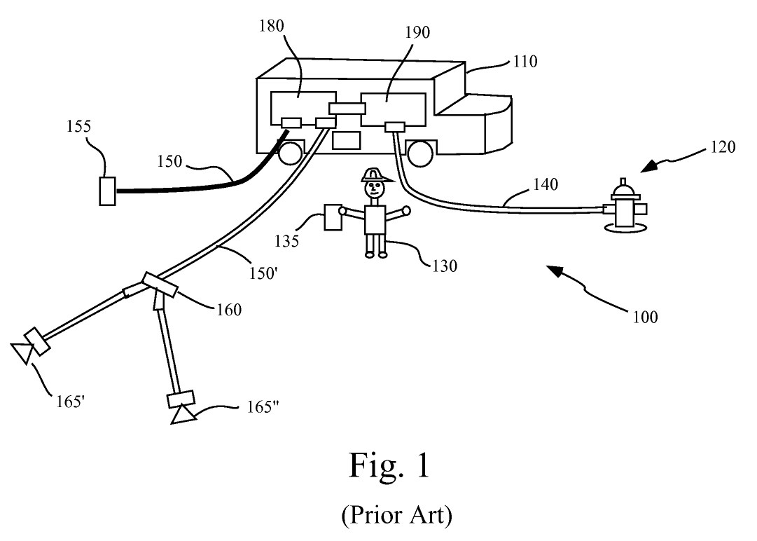

Representative embodiments according to the inventive subject matter are shown in FIGS. 1-10, wherein similar features share common reference numerals.

Now referring to prior art FIG. 1, which depicts the general configuration 100 of the fire truck 110, the fire hydrant 120, and the fire engineer 130. The fire truck 110 is connected to the hydrant 120 by a hydrant hose 140. Water from the hydrant 140 is fed to a fire truck tank 190, which is then pumped by an internal pump 180 to hoses 150, 150′. The hoses 150, 150′ may be further connected to a nozzle 155, or a wye 160, and the wye 160 is further connected to nozzles 165′, 165″. In normal operation, hydrant hose 140 is not connected until after the truck is pumping water, thus, the amount of water in the fire truck tank 190 runs the risk of depletion. This rate of depletion can be altered by the firefighters adjusting the nozzles 155, 165, 165″. It is the role of the engineer 130 who currently estimates using flow tables 135 to determine which adjustments need to be made.

The inventive subject matter recognizes that actual nozzle PSI could be sensed and wirelessly communicated, e.g., transmitted directly to the engineer's panel for every pre-connected hose lay.

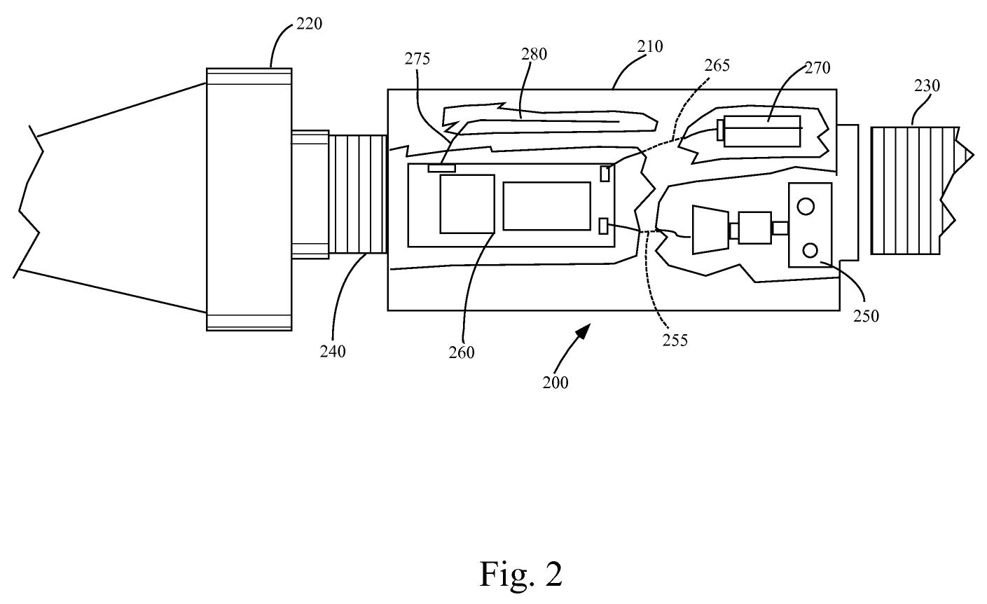

Now referring to FIG. 2, that depicts a cutaway view of the wireless, piezometer-based water flow monitoring system. The flow monitoring system 210 is position in-line with the nozzle 220 and the hose 230 with threaded connections 240. Internally the system shows a transmitter circuit board 260, a sensor arrangement 250. Also connected to the transmitter circuit board 260 is a transmitter power supply 270. A transmitter antenna 280 is also connected the transmitter circuit board 260. In the preferred embodiment, the flow monitoring system has dimensions of approximately 9 inches in length and six inches in diameter. Internally it is designed to not restrict waterflow.

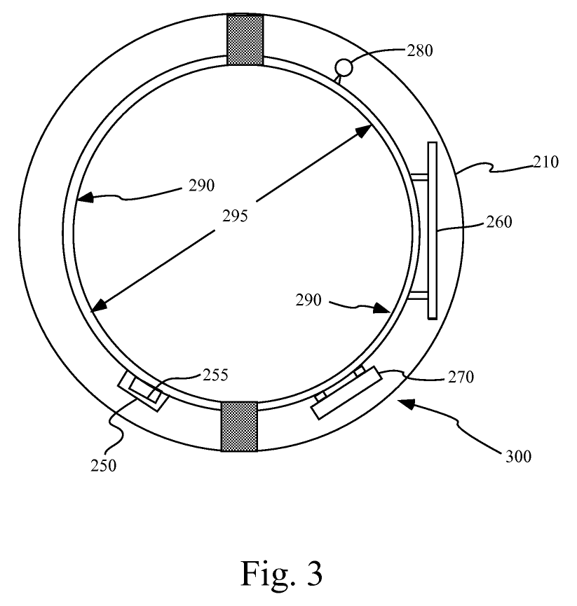

Now referring to FIG. 3, an axial view of the monitoring device 210 shows a sensor arrangement 250, the transmitter antenna 280, the transmitter circuit board 260. As contemplated a device that fits behind and adjacent to the nozzle 220 in the hose 230 lay. The monitoring device 210 includes a conduit 290 for water flow (e.g., from the hose connected to one end of the device) there through and into the nozzle. The conduit 290 may be variously implemented. As an example, the conduit 290 may have a selected diameter 295, which diameter 295 is no less than the diameter of the nozzle at the point of connection between the nozzle and the device. As another example, the conduit 290 may have a constant or substantially constant diameter 295 along it's selected longitudinal dimension and shape. The device also contemplates a sensor arrangement 250 for sensing a selected operating parameter, e.g., water pressure and/or water flow (e.g., either by rate—such as gallons per minute—or on a flow/no flow basis).

The sensor arrangement 250 may be variously implemented. In an example embodiment, the sensor arrangement 250 may be implemented so as minimize impact on one or more operating parameter(s) (e.g., the operating parameter(s) being sensed or any other parameter that, if altered, might alter the senses operating parameter(s)). In an example embodiment, the sensor arrangement 250 comprises an aperture 255 disposed in and laterally from the side of the device's conduit, in association with which a sensor is provided (e.g., mounted at the end of the aperture opposite the device's side). The aperture's 255 dimensions (size/shape of opening, its depth and its size/shape along its depth) may be variously selected. As an example, the aperture's 255 dimensions may be selected based on various factors (examples include one or more of minimizing clogging, enabling self-unclogging, minimizing creation of turbulence under flow conditions, and minimizing alteration of pressure in the conduit under flow conditions).

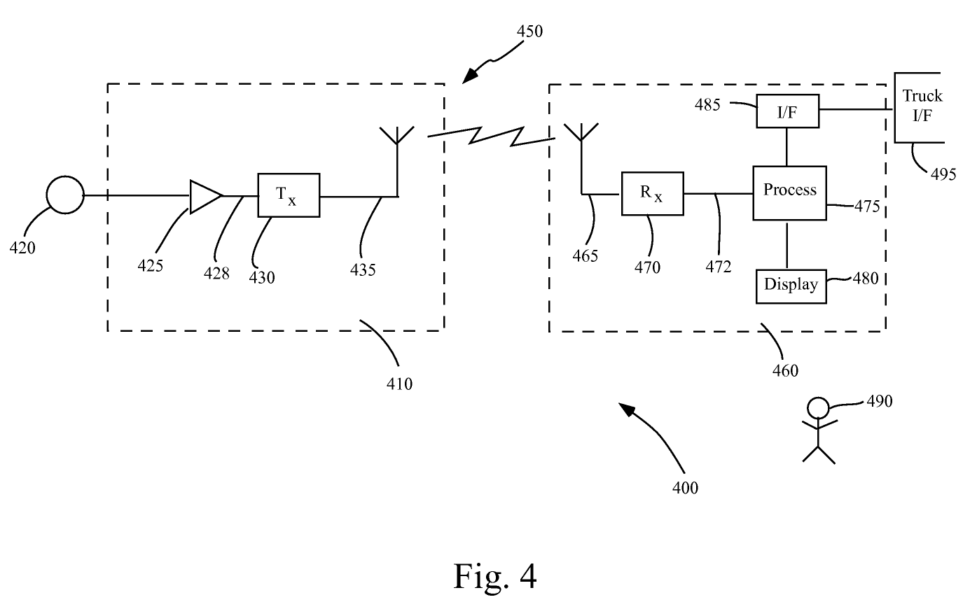

Now referring to FIG. 4 that depicts a flow monitoring system 400. The flow monitoring system 400 has a sensor 420, a transmitter subsystem 410, and a receiver subsystem 460. The transmitter subsystem 410 is connected to the sensor 420 and the receiver subsystem 460 via a wireless link 450. The receiver subsystem 460 is connected to the end user 490.

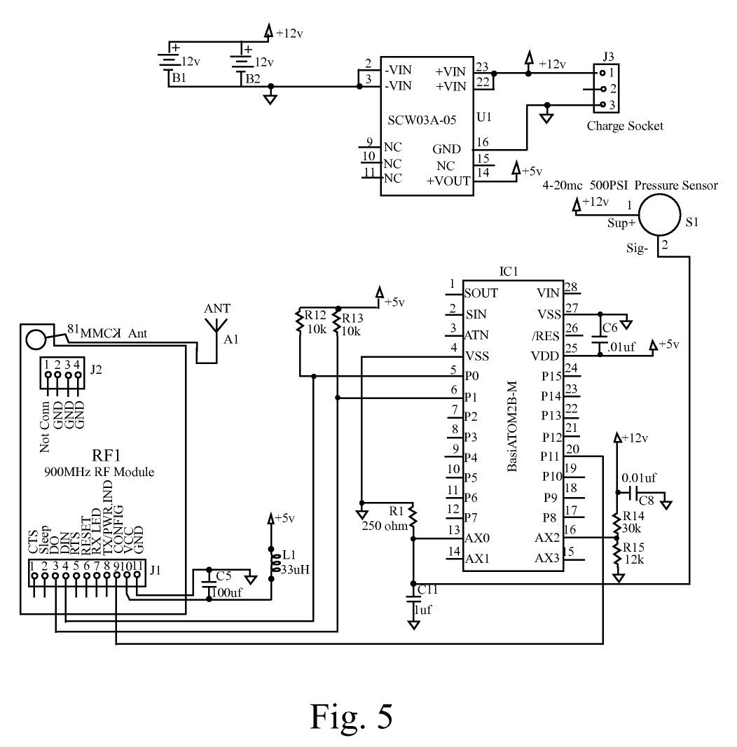

The transmitter subsystem 410 incorporates an analog to digital converter 425, a digital transmitter interface 430, and a transmitting antenna 435. The analog to digital converter 425 converts the analog signal from the sensor 420 and feeds it in a digital format 428 to the transmitter interface 430, which then transmits on the antenna 435. The transmitting antenna 435 is physically dimensioned to transmit on a suitable frequency, which is approximately 3 inches on the 900 MHz band. The transmission frequency for the 900 MHz frequency band is not limited to exactly 900 MHz, but a range of frequencies around that band as recognized by those skilled in the arts. Also by reference to FIG. 5, an embodiment of the transmitting subsystem is represented by a schematic.

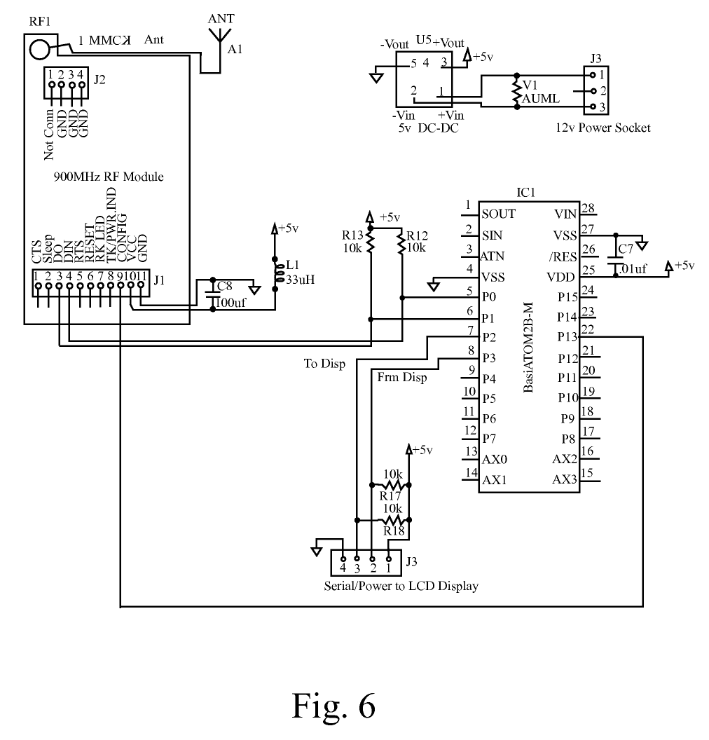

The receiver subsystem 460 incorporates a receiving antenna 465, a receiver 470, a processor 475, a display module 480, and an apparatus interface 485. The receiving antenna 465 is electrically connected to the receiver 470 that produces a digital output 472 from the radio frequency input. The data on the digital output 472 is the same as the data on the digital input 428. The data on the digital output 472 is fed into the processor 475, which converts the data to the display 480. The display 480 is read by the operator 490. Also by reference to FIG. 6, an embodiment of the receiving subsystem is represented by a schematic.

The transmitting subsystem 410 may be integrated into a nozzle, in whole or in part. As an alternative, the components may be implemented, e.g., in a fitting or other device, for in-line disposition behind the nozzle but substantially adjacent to the nozzle. Moreover, some of the components may be disposed separately from the nozzle and the hose lay (e.g., the communication module may comprise a lower power submodule disposed in association with the sensor arrangement which communicates to a second submodule carried by a firefighter, such second submodule communicating with the fire apparatus employing technology of higher power, range, bandwidth or otherwise.

The sensor arrangement may be variously implemented. As an example, the sensor arrangement may be implemented to sense water pressure and/or flow. As an example, the sensor arrangement may be implemented to sense one or more selected parameters at one or more selected locations of one or more hose lays (e.g., pressure is sensed at or adjacent to or otherwise associated with the orifice of the nozzle).

Now referring back to FIG. 3. The sensor arrangement 250 may comprise or be in association with a port 255. A port 255 is an area in the nozzle for the mounting of the sensor arrangement 250. A port 255 may be variously implemented. As an example, a port 255 may be implemented so as to enable the sensor to sense the pressure of the water, while having dimensions so as to preclude debris from clogging (which clogging would tend to impede the sensor's proper operation). The port 255 may be disposed variously, including, as examples, in a length of the nozzle or in an area of substantially uninterrupted flow. The port 255 may be positioned, dimensioned and implemented so as to minimize effect on the pressure being sensed, (e.g. by minimizing turbulence, variations of diameter).

Now referring back to FIG. 4, the display 480 may be variously implemented. As an example, it may be implemented to display visually processed telemetry information, e.g., responsive to the sensed: 1. psi 2. battery level 3. signal strength 4. some assigned identifier for the hose lay. The display 480 may also be implemented to include a keyboard, mouse or other device for the user to input or select data.

The apparatus interface 485 may be variously implemented. The apparatus interface 485 provides a means for the processor to communicate the telemetric data with the pumper truck interface 495. The pumper truck interface 495 generally is implemented to provide a signal interface between the processor and the electronic governor of the fire apparatus, so that the governor can receive and respond to the signal provided from the processor (e.g., comprising and otherwise relating to the telemetry data).

In operation at the receiving end, the processor 475 converts data from the communication module and delivers that data to the display 480 and/or to the apparatus interface 485. The processor outputs control signals to the apparatus interface 485 which signals the apparatus interface 485 provides to the electronic governor of the fire apparatus 495. The electronic governor operates in accordance with those signals to control the pumps output (e.g. gpm and psi). The communication module communicates with the sensing end to receive telemetry and to provide received telemetry data to the processor. The communication module may be implemented so to transmit to the sensing end (e.g. sending control signals and/or data to the sensing end for use either by the sensing end or by a firefighter associated therewith).

In operation at the transmitting module, the sensor arrangement 420 captures pressure data from water flow and converts that to an electronic signal. The analog to digital converter 425 processes the electronic signal (e.g. sampling the pressure data at selected intervals, storing it, selecting from sampled data, averaging selected data). The analog to digital converter 425 may also be implemented so as convert pressure data of certain values to one or more predetermined values (e.g., if a non-zero value is sensed when the pressure is zero, the non-zero value is zeroed). The analog to digital converter 425 may also be implemented to provide for calibration (e.g., to enable the processor to send accurate telemetry data regardless of the operating characteristic of a sensor, which characteristic may change over time and/or may vary if the sensor is replaced).

As an example, the digital transmitter interface 430 may be implemented to sample sensor data at selected time intervals so as to minimize irrelevant data from being processed (e.g. irrelevant pressure transients may be minimized by sampling at 5 ms intervals).

The digital transmitter interface 430 may be also implemented to identify the voltage, current or other power characteristics of the power source, e.g., so as to determine or warn of appropriate action(s). To illustrate, if a low power circumstance is identified, the sensing end may do one or more of: sending a “low battery” signal to the controlling end, activating a local alarm for a firefighter associated with the sensing end, and transitioning to a power saving mode.

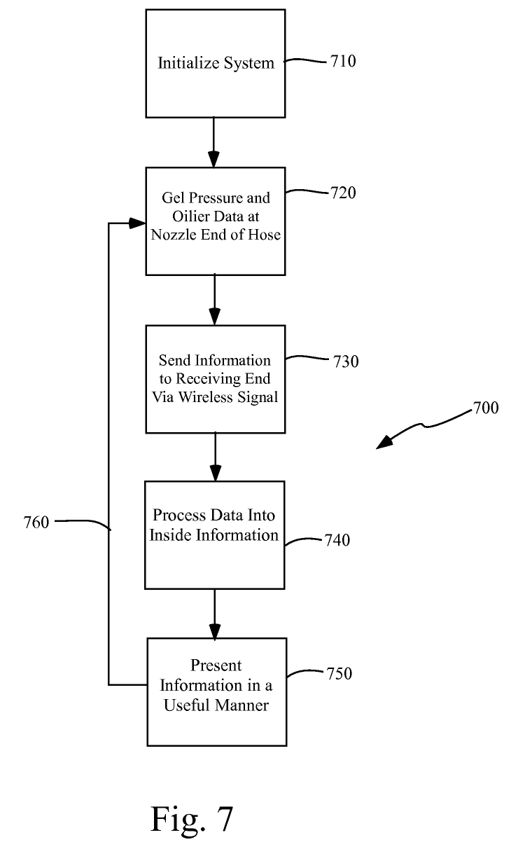

Now referring to FIG. 7 which shows the general method of system operation 700. Upon starting the system is initialized with default parameters 710. The transmitter subsystem reads the pressure and other applicable parameters at the end of the hose 720. This information is transmitted to the receiving subsystem 730. The receiving data is then converted into readable output 740,750. This process is then repeated to update the output 760.

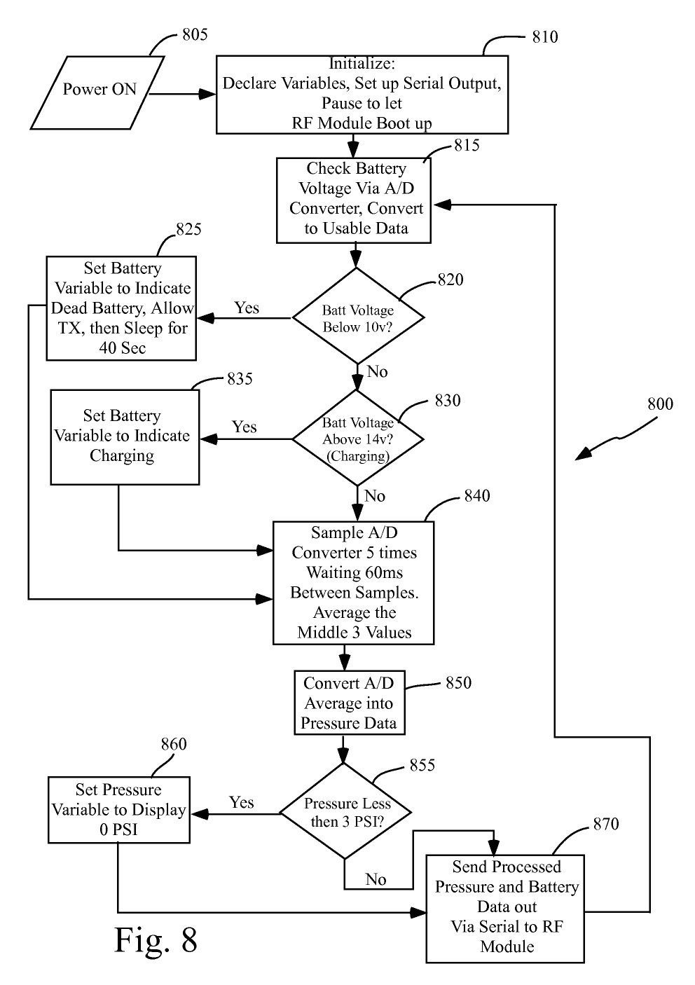

Now referring to FIG. 8 which depicts a detailed flowchart for operating the transmitter subsystem 800. The first step requires power on 805 and initialization 810 of the subsystem. The next step 815 checks the power level of the battery and determines if the system has a dead battery 820 or charging 830.

The transmitter subsystem then begins analog to digital conversion 840 at periodic intervals with the option of averaging several reads. For example, sample intervals every 60 seconds may be sufficient to update the system. (e.g., toward coordinated sampling rate with the timing of a display implementation).

The analog data is converted into digital data 850 reflects an example implementation by converting the average of sensed data in obtaining pressure data. Moreover, generally, the conversion may be variously performed in a number a ways: using a formula or specification (such as provided with a transducer); using tables or other conversion data (e.g., a conversion or other look up table), or via tables that have been corrected via calibration (e.g., performed at the time of manufacturer and/or performed or refined by the user, such as at times other than fire events).

A bottom limit on pressure less then 3 PSI 855 and “Set Pressure variable to display 0 PSI 860 reflect a design implementation wherein misleading telemetry data is set to zero. If the pressure is of normal value it is sent to the transmitter module 870.

In an example of a processor implemented at the sensing end, the processor may be implemented so as not to perform one or more of the operations set forth above (e.g., not converting sensed signal to telemetry data). In such case, the operations may be performed, if at all, at the controlling end. Even so, the processor at the sensing end may be implemented to perform any such operation for various reasons (e.g., so as to enhance performance, efficiency, and reliability).

Where the sensing end is implemented as part of a device or fitting disposed adjacent the nozzle, the device or fitting generally has a conduit through which water is enabled to flow (e.g., to the nozzle). This conduit generally has an inside diameter. As an example, the inside diameter may be provided so that it is no less then the inside diameter of the intended nozzle and/or has a constant diameter.

Also the transmitting module may have embedded certain information relevant to that particular module itself. For example parameter(s) and providing feedback based thereon to the fire apparatus (e.g., to the engineer and/or the governor of the fire apparatus). The inventive subject matter also contemplates communicating feedback to command vehicles and fire apparatus of any combination of: a) personnel accountability Information that incorporates: (1) user name, (2) apparatus assignment, (3) tactical assignment; (b) SCBA air levels and alarm status; and (c) location which further incorporates: (1) GPS information, (2) triangulation of exact location with elevation; and c) thermal imagery and video transmissions.

Also associated with the nozzle end or otherwise in the hose lay, the inventive subject matter contemplates the physical implementation of the transmitter housing as: (1) aluminum machined casing (e.g., including ½ inch waterway); (2) durable plastic slip-cover with built-in water protection. Also contemplated in the transmitter housing are: (1) battery pack and battery level monitor, (2) antenna, (3) one or more transducers (e.g., piezoelectric-based, pressure sensor), (4) cabling for power connections and coupling between operating components (e.g., coax to antenna), (5) transmitter circuitry, (6) processor and software, and a (7) radio.

Future use of the transmitting system may include also contemplates adapting its use in various applications for remote monitoring of operating parameter(s), e.g., PSI, along any, selected point(s) of fluid-based systems, including, but not limited to: (a) irrigation, (b) industrial manufacturing, (c) hydraulic systems, (d) building systems.

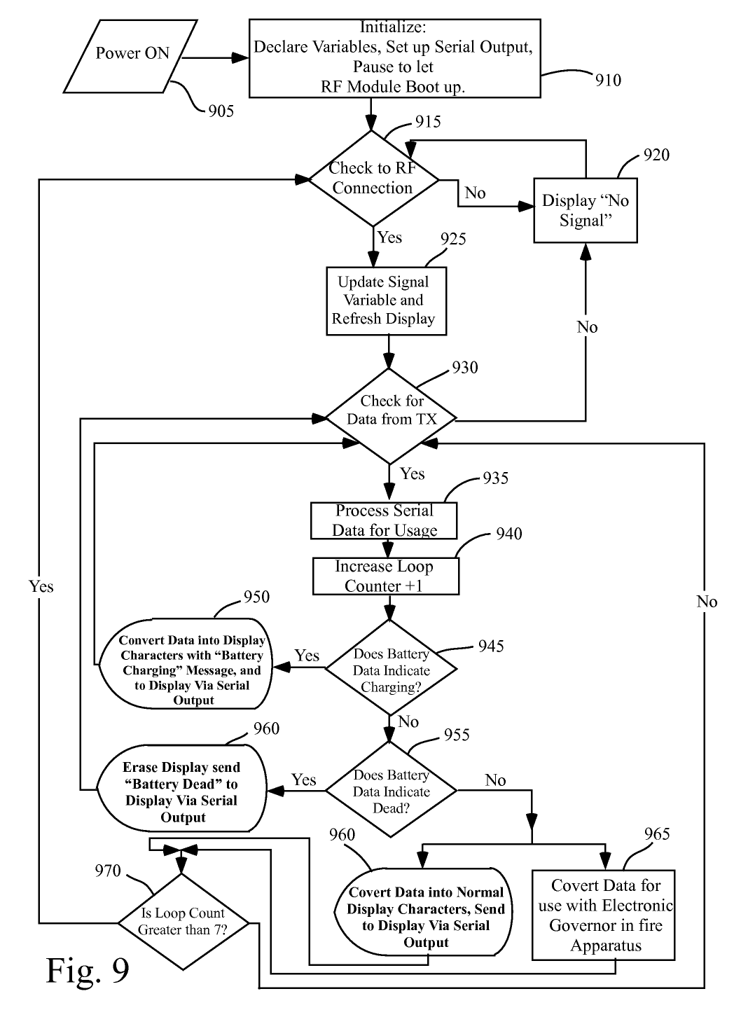

Now referring to FIG. 9, the flowchart for the receiver software 900. The receiver has a power up 905 and initialization 910 step. The receiver then checks for the RF connection 915. If there is no RF connection 915 and a signal indicator is set 920 to no signal. If there is a RF connection the display is refreshed and the signal indicator is set to signal 925. Data is then downloaded from the transmitter 930, the data is formatted from serial to parallel for use with the receiver processor, and a packet counter is set 940. The system checks battery status 945 setting a battery indicator 950; and also checking for a dead battery 955, sending that status to the screen 960. Next the output data is reformatted for the display 960 or an interface with the fire equipment. Lastly, the system checks every seven loops to determine if the RF connection is still active 970.

Associated with the display software is an interface (LCD, LED, etc.) that displays one or more or, for example: (a) PSI at the transmitter end, (b) battery level at the transmitter end; c) signal strength; and/or d) hose lay identifier Associated with the receiver circuitry, the system contemplates, for example: processor and software; radio; power connections; cabling (e.g., coax) with fittings to the antenna; and an antenna.

Associated with the wireless link are options for use, for example: (1) by the FCC governed public radio bandwidth; (2) Public Safety radio bandwidth; (3) Combination of frequencies, (4) Selected protocol(s), e.g., 802.11, mobile telephonic technologies, etc, (5) wired, (6) through fluid communications.

Other options include that the acquired data may be water pressure data, which data is directed to the water in or flowing through a hose lay.

Also the acquired data may be water pressure data associated with the water flowing out the end of the hose lay, e.g., out of a nozzle's orifice.

Also, the acquired data may be water pressure data associated with the water flowing through the nozzle. Such water pressure data may be acquired at any point within the nozzle. Generally, the water pressure data is acquired using a pressure sensor arrangement disposed in the nozzle itself.

Also the acquired data is water pressure data associated with water flowing into the nozzle. Such water pressure data may be variously acquired. In an example, the water pressure data is acquired using a device fitted or otherwise disposed behind and adjacent to the nozzle in the hose lay (e.g., between (a) the end of the hose of the hose lay and (b) the nozzle).

Also the acquired water pressure data may be acquired variously. Generally, this data may be acquired using any of various sensors. An example of such sensors includes: (a) a piezometer (e.g., disposed in or in appropriate association with the nozzle).

Also the acquired water pressure data may be acquired at various times. As examples, the water pressure data may be acquired according to any one or more of the following: (a) continuously and/or at various fixed intervals, (b) at any time or selected times responsive to the flow of water, (c) while a power source is sufficient to both transmit, (d) while a communication connection is established (i.e., no acquisition if the corresponding link is lost such that communication cannot proceed), (e) in response to a received, acquisition-triggering signal (e.g., such signal being responsive to fire fighter action, or received from the pumper or a firefighter associated with the pumper or otherwise from a source associated with the pumper), and (f) unless the acquisition is turned off.

Also the sensed data may or may not be conditioning at or near the remote location. If used, such conditioning may be variously implemented. As an example, such conditioning includes conversion from an analog to a digital signal, deleting or otherwise discarding an acquired water pressure (e.g., so as to selectively control the amount of acquired data points for transmission), truncating the bits to a select number of most significant bits, and translating the acquired data into water pressure data.

Also the sensed data may be transmitted through any known communication mechanism. Examples include wired and wireless mechanisms.

Moreover, that a wired system may be variously implemented. Examples include using a wired electrical conduit built into the hose or one separate from the hose. As well, examples include, depending on the hose materials, using one or more selected components of the hose itself as a transmission medium.

Also, that a wireless system may be variously implemented. Examples of a wireless system include using wireless technology such as 802.11 technologies, cellular telephony technology, or other technologies that use the surrounding air as the transmission medium. Examples of a wireless system include using the water in the hose as the transmission medium.

Further that the acquired data that is transmitted to the pumper may be transmitted either directly to or indirectly to the pumper. As an example the data may be transmitted so as to be received by one or more receiver units used by respective fire fighters disposed either at or around the nozzle or remote from the nozzle. As to firefighters disposed at or in association with the pumper, the firefighters may use that data toward manual control of the pumper or toward checking that the pumper is responding properly (i.e., in case an override is required). As to other firefighters, the data may be used to command and control the fighting of the fire, e.g., toward obtaining and deploying resources. As to firefighters at or around the nozzle, the information may be provided so as to signal proper or improper water pressure, so as to enable appropriate action (e.g., to communicate to the pumper or firefighters associated therewith so as to override the system or to initiate backup procedures through the system or to otherwise address the information). If raw data is transmitted to such firefighters, the data may be conditioned and analyzed by modules so as to provide warning lights or sounds or to drive a display of readable numbers or other form that the firefighters will appreciate as water pressure data.

Other example embodiments contemplate having an integrated wireless system that would not only give feedback to the engineer on the nozzle PSI, but also would give one or more of command accountability, air status, location, video displays, temperature and/or other information. Any particular such other information may be communicated (e.g., wirelessly) to one or more selected users, including some combination of engineer, commander(s) and firefighters.

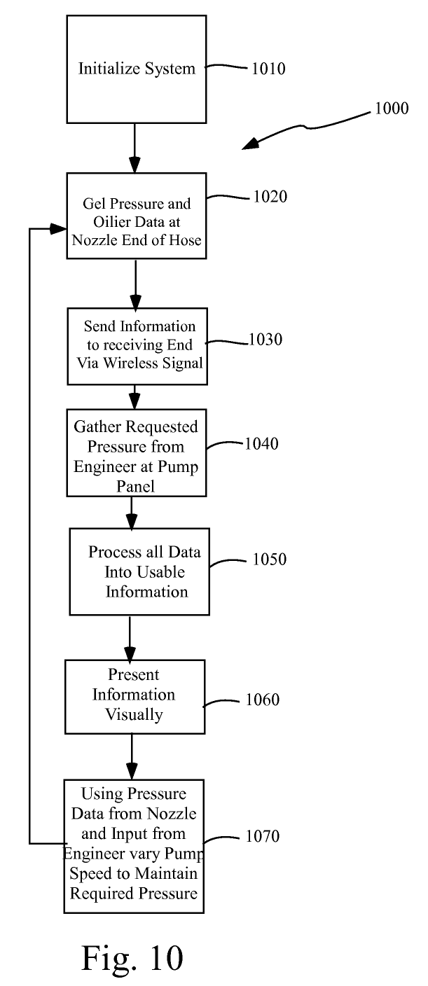

Now referring to FIG. 10 a flowchart for a closed loop control system is depicted 1000. The first step 1010 is to initialize the system. The next step 1020 is to get pressure and data from the nozzle end of the hose. The next step 1030 is to send the nozzle pressure and data from the hose via wireless connection. The next step 1040 is to gather pressure information at the pump panel from the engineer. The next steps 1050,1060 processes that information to present it to the engineer in acceptable units on the display. The next step 1070 is to use the information on the display to vary the pump speed.

Further, the transmitted, acquired data may be received at or in association with the pumper (“received data”) and, generally, is used in controlling the pumper so as to deliver a proper water pressure from the nozzle. The received data may be used as received or may be conditioned and/or analyzed.

Likewise the received data may be an input to an algorithm that sends control signals to the pumper truck's pump, resulting in control of pumping parameters responsive to the sensed data. The algorithm may be variously implemented. As an example, an algorithm may be implemented as software or firmware that is executed on or by a controller circuit (e.g., a microprocessor, microcontroller, ASIC, FPGA etc).

In another embodiment, the sensor is integrated with a control device that directly controls the amount of water output. Data collected at the pump is transmitted to the engineer. The engineer then remotely controls the amount of water output at the nozzle. Alternately, the amount of water can be controlled locally using a closed loop controller directly integrated within the device.

In another embodiment the sensor is integrated directly into the nozzle of the hose. This allows for easier deployment because the in-line attachment is integrated with the nozzle.

Also alternative algorithms may be used so as to control water pressure. These algorithms may be PID (proportional, integral, and derivative) algorithms, state space controls algorithms, or non-linear algorithms.

Persons skilled in the art will recognize that many modifications and variations are possible in the details, materials, and arrangements of the parts and actions which have been described and illustrated in order to explain the nature of this inventive concept and that such modifications and variations do not depart from the spirit and scope of the teachings and claims contained therein.

1. In fire-fighting, a method of controlling operation of a fire apparatus as to at least one hose lay, the method comprising:
(i) acquiring data at a location associated with the hose lay;
(ii) communicating at least some of the acquired data from the remote location so as to be receivable at or adjacent to the fire apparatus; and
(iii) based at least in part on at least some of the so-communicated data, controlling the operation of the fire apparatus.

2. The method as claimed in claim 1, wherein communicating further comprises a wireless communications link.

3. The method as claimed in claim 1, wherein acquiring data further comprises water pressure data.

4. The method as claimed in claim 3, wherein said acquired water pressure data further comprises data at or adjacent to the nozzle of the hose lay.

5. The method as claimed in claim 3, wherein said acquired water pressure data further comprises data related to water pressure at or adjacent to an appliance of the hose lay.

6. The method as claimed in claim 1, wherein acquiring data further comprises water flow data.

7. The method as claimed in claim 1, wherein controlling the operation of the fire apparatus further comprises enabling an engineer to control the operation based on providing information to the engineer at a human interface, the information being based at least in part on at least some of the so-communicated data.

8. The method as claimed in claim 1, wherein controlling operation of the fire apparatus further comprises automatically controlling operation of the fire apparatus.

9. The method as claimed in claim 8, wherein controlling operation of the fire apparatus further comprises enabling an engineer to participate in controlling the operation based on providing information to the engineer at a human interface, said information being based at least in part on at least some of the so-communicated data.

10. The method as claimed in claim 1, further comprising processing at least some of the acquired data so as to convert such data to accurate or substantially accurate data.

11. The method as claimed in claim 10, wherein processing comprises using calibration information.

12. A fire fighting apparatus, said fire fighting apparatus comprising;
a data acquisition sensor; said sensor generating data concerning a hose lay;
a transmitter electrically connected to the data acquisition sensor;
a receiver electrically connected to the transmitter;
and fire apparatus controlling device electrically connected to the receiver.

13. A fire fighting apparatus as in claim 12, wherein said data acquisition sensor further comprises a water pressure sensor.

14. A fire fighting apparatus as in claim 12, wherein said data acquisition sensor further comprises a water flow sensor,

15. A fire fighting apparatus as in claim 12, wherein said hose lay further comprises a fire nozzle, said data acquisition sensor integrated within the fire nozzle.

16. A fire fighting apparatus as in claim 12, wherein said hose lay further comprises an insert, said data acquisition sensor integrated within the insert.

17. A fire fighting apparatus as in claim 12, wherein said electrical connection from said receiver to said transmitter further comprises a wireless connection.

18. A firefighting apparatus as in claim 17, where said wireless connection operates on the 900 MHz frequency band.

19. A water nozzle, comprising a housing defining a fluid supply passage through the housing, a sensor located in the passage, and a data acquisition system located within the housing for receiving a signal and configured to communicate data concerning water flow parameters within the passage to a controller associated with a remote water supply for the water nozzle.
